(19) United States
(12) Patent Application Publication
(10) Pub. No.: US 2008/0167985 A1
(43) Pub. Date: Jul. 10, 2008

(54) Internet Based Animal Tracking Information System

(75) Inventor: Robert G. Yarnall, Morgantown, PA (US)

Correspondence Address: RATNERPRESTIA, P O BOX 980, VALLEY FORGE, PA, 19482-0980, US

(73) Assignee: AMERICAN CANNE ASSOCIATION, INC., Wilmington, DE (US)

(21) Appl. No.: 11/587,708

(22) PCT Filed: Apr. 27, 2005
(86) PCT No.: PCT/US05/14566

§ 371 Date: Feb. 14, 2008

Related U.S. Application Data
(60) Provisional application No. 60/565,927, filed on Apr. 27, 2004.
(60) Provisional application No. 60/575,588, filed on May 28, 2004.

(51) Int. Cl. G06Q 99/00

(52) U.S. Cl. 705/39; 705/1

(57) ABSTRACT

An Internet based animal tracking system that allows owners of an animal and other authorized users to securely input and/or access animal records. Once the animal's record is entered, it may be securely accessed by government entities and/or veterinary representatives for the purpose of tracking the animal's location, ownership, and other data related to the said animal. Record keeping is maintained by a secure Internet server. The method allows regulatory government agencies to trace the historical ownership, geographic locations, and other records of an animal.

### CROSS REFERENCE TO RELATED APPLICATIONS

This application claims the benefit of priority to U.S. Provisional Application Ser. No. 60/565,927, filed Apr. 27, 2004 and to U.S. Provisional Application No. 60/575,588, filed May 28, 2004, the contents of each being incorporated by reference herein.

### FIELD OF THE INVENTION

This invention relates to systems for tracking animal information. More particularly, this invention relates to an Internet based animal tracking system that allows owners of an animal and others so authorized to securely input and access animal records.

### BACKGROUND OF THE INVENTION

Breeders, owners, veterinarians, and government agencies need to know and understand a great deal of information about animals in their possession, custody, control, and ownership. For example, they need to know an animal's physical and biological attributes, genetic makeup, inheritable diseases and disorders, and communicable diseases and disorders. Animals are often moved from one location to another location during their lifetimes. Consequently, they may be come into contact with infected animals, eat defective feed, and infect other animals. They may also be treated by more than one veterinarian. At times, it may be important for a current owner of the animal, for a current veterinarian treating the animal, or for a government agency to have access to historical information about the animal.

U.S. Pat. No. 5,478,990 issued to Montanari et al. describes a process of tracking food products and/or food supplements coupled with a system of generating additional labels as required for identifying various portions of food products. Furthermore, Montanari's patent describes a system that requires the owner of an animal to maintain their records on their own computer. Additionally, Montanari's system of generating labels adds great cost to individuals utilizing Montanari's system.

U.S. Pat. No. 5,900,818 issued to Lemnell describes a system for indicating the direction and tracking of hunting dogs while engaged in hunting activities. Lemnell's patent is comprised of a radio frequency transmitting device.

U.S. Pat. No. 6,323,771 issued to Payne et al. describes a method of identifying animals involving the use of a universal identification scheme. Payne's universal identification scheme requires that a unique formatted number be assigned to the animal and said number would link the animal to a geographic indexing method.

U.S. Pat. No. 6,424,727 issued to Musgrave et al. describes a system and method of animal identification and animal transaction authorization using iris patterns. Musgrave's patent requires the use of expensive equipment and sophisticated computer programs to analyze the iris patterns matching animal to owner.

U.S. Pat. No. 6,375,612 issued to Guichon et al. describes a method and system of monitoring animals. Guichon collects data determining the position of each animal within a specific area at predetermined intervals. Guichon then analyses the collected data to determine at least one physical condition of the animal.

U.S. Pat. No. 6,154,213 issued to Rennison et al. describes a method of operating a “search engine” on the World Wide Web.

U.S. Pat. No. 6,537,213 issued to Dodds describes a phenotype database of non-livestock pet animals and their laboratory test data. Dodds analyzes the test results of individual animals and compares the results to previously entered data of the animal and/or to genetically related non-livestock pet animals.

U.S. Pat. No. 6,360,215 issued to Judd et al. describes a method and apparatus for retrieving documents based on information other than document content. Similar to the previously described Rennison patent, Judd's patent is an alternate method of operating a “search engine” on the World Wide Web.

U.S. Patent Application Publication No. 2004/0039258 filed by Dodds describes a method of obtaining and electronically delivering a diagnosis of the health of an animal through a combination of computerized data and human interpretation. A fluid sample from the animal is reported through an Internet network to a clinical pathologist who makes a diagnosis. Additional information may be entered into the computer and an integrated report is electronically communicated to a client.

### SUMMARY OF THE INVENTION

This invention relates to an Internet based animal tracking system that allows owners of an animal to securely input and access animal records. Once the animal's record is entered, it may be securely accessed by government entities and/or veterinary representatives for the purpose of tracking the animal's location, ownership, and other data related to the animal. According to one aspect, the present invention is designed to have the record keeping maintained by a secure Internet server, thus only requiring the owner to have Internet access and eliminate the need for the owner to have a computer, install additional data management programs, or maintain a database on their Internet access device.

The present invention also provides a unique architecture for regulatory government agencies to trace the historical ownership, geographic locations, and other records of an animal in an unprecedented rapid rate of time. Current methods of tracking the identification of animals are deficient in that they do not allow government representatives immediate, automated remote access to recorded information such as current owner, current location, animals veterinary history, unique identification, disease tracking and isolation control.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is an illustration of a secure User Login screen in accordance with an exemplary embodiment of the present invention;

FIG. 2 is an illustration of an exemplary User Login screen in accordance with another exemplary embodiment of the present invention;

FIG. 3 is a flow diagram illustrating the operation of a User Login screen's random security code generator in accordance with an exemplary embodiment of the present invention;

FIG. 4 is a graphic representation and illustration of an exemplary code that may be produced by the random security code generator illustrated in FIG. 3;

FIG. 5 is a flow diagram illustrating an operation of an exemplary User Login screen's random security code generator coupled with an exemplary random background image generator in accordance with an exemplary embodiment of the present invention;

FIGS. 6-8 are exemplary and illustrative graphic representations of background images that may be produced by a background image generator illustrated in FIG. 5;

FIG. 9 is a graphic representation and illustration of an exemplary embodiment of a User Login screen's randomly generated security code combined with an illustrative randomly generated background image described in FIG. 5;

FIG. 10 is an overview illustrating a manner in which a user may access the present invention;

FIG. 11 is an overview illustrating a manner in which a user may access the present invention coupled to an automated electronic payment processing company;

FIG. 12 is an exemplary flow diagram illustrating User Login screen's security logic features coupled with an ability to sort and direct users to predetermined security levels and applications in accordance with an exemplary embodiment of the present invention;

FIG. 13 is an exemplary flow diagram illustrating an ability to sort and direct users to predetermined security levels and applications in accordance with an exemplary embodiment of the present invention;

FIG. 14 is a graphic representation of an animal that carries a microchip used for unique identification;

FIG. 15 is a graphic representation of an exemplary method showing how a government representative may acquire the microchip identification number of an animal using a universal or other microchip scanner;

FIG. 16 is a graphic representation of an animal that has an illustrative tattoo that may be used for unique identification;

FIG. 17 is a graphic representation of an animal that has a tag attached to its collar for unique identification;

FIG. 18 is a graphic representation of an animal's DNA sample used for unique identification;

FIG. 19 is a graphic representation of the transfer of ownership of an animal;

FIG. 20 is an illustration of an indexed ownership table of an animal in accordance with an exemplary embodiment of the present invention;

FIG. 21 is an illustration of an indexed owner's address table in accordance with an exemplary embodiment of the present invention;

FIG. 22 is an illustration of an indexed facility location address table in accordance with an exemplary embodiment of the present invention;

FIG. 23 is an illustration of an indexed identification table of an animal in accordance with an exemplary embodiment of the present invention;

FIG. 24 is an illustration of an indexed veterinary health record table of an animal in accordance with an exemplary embodiment of the present invention;

FIG. 25 is an illustration of an indexed animal owner table that may be used to show multiple animals owned at different locations in accordance with an exemplary embodiment of the present invention;

FIG. 26 is an illustration of an indexed contagious disease-tracking table of an animal that may be used in accordance with an exemplary embodiment of the present invention;

FIG. 27 is a graphic representation of an owner of an animal initiating the breeding of a male and female to produce offspring;

FIG. 28 is a graphic representation of a female animal producing offspring after being bred;

FIG. 29 is a graphic representation of a transfer of ownership of an animal's offspring to a new owner;

FIG. 30 is an overview flow chart illustrating a manner in which an animal's owner who is a breeder may use the present invention;

FIG. 31 is a graphic overview illustrating a manner in which a new owner of offspring from an animal may use an exemplary embodiment of the present invention;

FIG. 32 is a graphic overview illustrating a manner in which a government representative may use an exemplary embodiment of the present invention;

FIG. 33 is a graphic overview illustrating a manner in which a veterinarian may use an exemplary embodiment of the present invention;

FIG. 34 is a graphic overview illustrating a manner in which multiple users may access an exemplary embodiment of the present invention;

FIG. 35 is a graphic exemplary overview illustrating a manner in which a government representative may use a wireless mobile method to access predetermined computer programs, processes, and data fields of an exemplary embodiment of the present invention;

FIG. 36 is a graphic exemplary overview illustrating a manner in which a government representative may use a wireless mobile method to access predetermined computer programs and data fields coupled with a printer of an exemplary embodiment of the present invention;

FIG. 37 is a graphic exemplary overview illustrating a manner in which a government representative may use a wireless mobile method to access predetermined computer programs and data fields coupled with a portable battery supply or other power supply of an exemplary embodiment of the present invention;

FIG. 38 is a graphic exemplary overview illustrating a manner in which a government representative may use a wireless mobile method to access predetermined computer programs and data fields of an exemplary embodiment of the present invention;

FIG. 39 is a graphic exemplary overview illustrating how an exemplary embodiment of the present invention may be coupled to a user data storage device allowing a user to store a copy of the user's data at the user's location;

FIG. 40 is a flow diagram illustrating how an animal owner may access and use predetermined, exemplary, functions of the present invention in accordance with an exemplary embodiment of the present invention;

FIG. 41 is a flow diagram illustrating how an animal owner may access and use predetermined, exemplary, functions of the present invention coupled with an automated electronic payment processing company in accordance with an exemplary embodiment of the present invention;

FIG. 42 is a flow diagram illustrating how a veterinarian may access and use predetermined, exemplary, functions in accordance with an exemplary embodiment of the present invention;

FIG. 43 is a flow diagram illustrating how a veterinarian may access and use predetermined, exemplary, functions in accordance with an exemplary embodiment of the present invention coupled with an exemplary automated electronic payment processing company;

FIG. 44 is a flow diagram illustrating how a government representative may access and use predetermined, exemplary, functions in accordance with an exemplary embodiment of the present invention;

FIG. 45 is a flow diagram illustrating how a government representative may access and use predetermined, exemplary, functions in accordance with an exemplary embodiment of the present invention coupled with an automated electronic payment processing company;

FIG. 46 is a graphic overview illustrating the table in FIG. 22 in accordance with an exemplary embodiment of the present invention;

FIG. 47 is a graphic overview illustrating how an exemplary embodiment of the present invention may link multiple owners of animals to one or more physical locations;

FIG. 48 is a graphic overview illustrating the table in FIG. 22 in accordance with an exemplary embodiment of the present invention;

FIG. 49 is a graphic representation of other living creators that may be tracked by an exemplary embodiment of the present invention after having an identification placed on or in them; and

FIG. 50 is a flow diagram illustrating exemplary information that may be entered into, stored, and retrieved in accordance with an exemplary embodiment of the present invention.

### DETAILED DESCRIPTION OF THE INVENTION

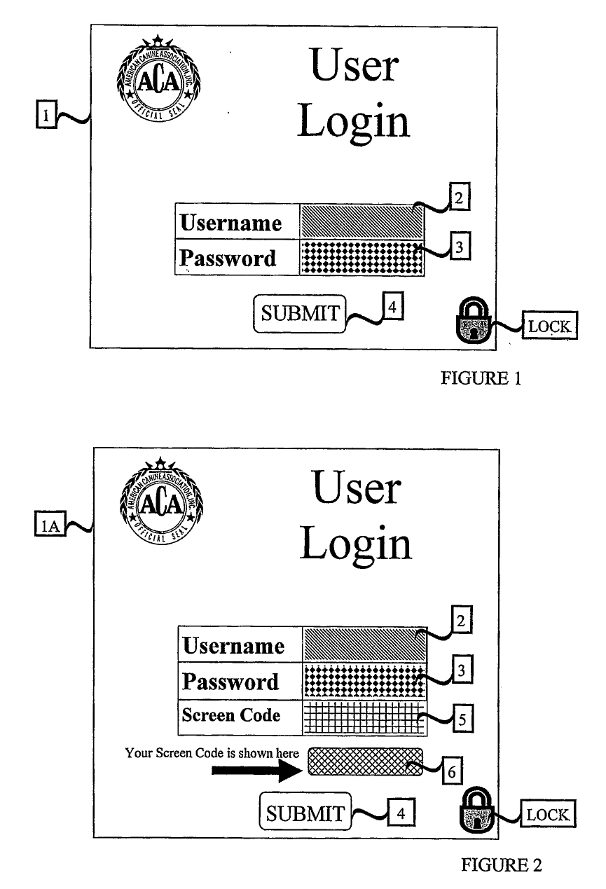

FIG. 1 is an illustration of a secure User Login screen in accordance with an exemplary embodiment of the present invention. More particularly, FIG. 1 shows an exemplary graphic representation of User Screen Shot (1) as seen when accessing an exemplary embodiment of the present invention. Username Data Entry Area (2) allows an authorized user of the system to enter a pre-authorized username. Password Data Area (3) allows an authorized user of the system to enter a predetermined password linked with the predetermined username. A user of the system may also be referred to as a client of the system. It will be understood that any reference to any user in this specification includes an authorized user. Submit Button (4) keys the system to submit the data entered in Username Data Entry Area (2) and Password Data Area (3) to present to an authorized user the invention's system via a communication network such as the Internet. Connection to the network may be via well-known means, such as hard-wired or wireless communication channels. Security Image Lock (LOCK) may inform the user of the system that all data is securely encrypted and that well-known and established security protocols are being properly observed by the Internet based system of the exemplary invention.

FIG. 2 is an illustration of an exemplary User Login screen in accordance with another exemplary embodiment of the present invention. More particularly, FIG. 2 shows an exemplary graphic representation of User Screen Shot (1A) as seen when accessing an exemplary embodiment of the present invention. The Screen Shot (1A) illustrated in FIG. 2 is similar to the Screen Shot (1) illustrated in FIG. 1 except that Screen Shot (1A) illustrates the inclusion of Screen Code Data Entry Area (5), which may allow a user to input a code shown to the user in Screen Code Image (6) (described below).

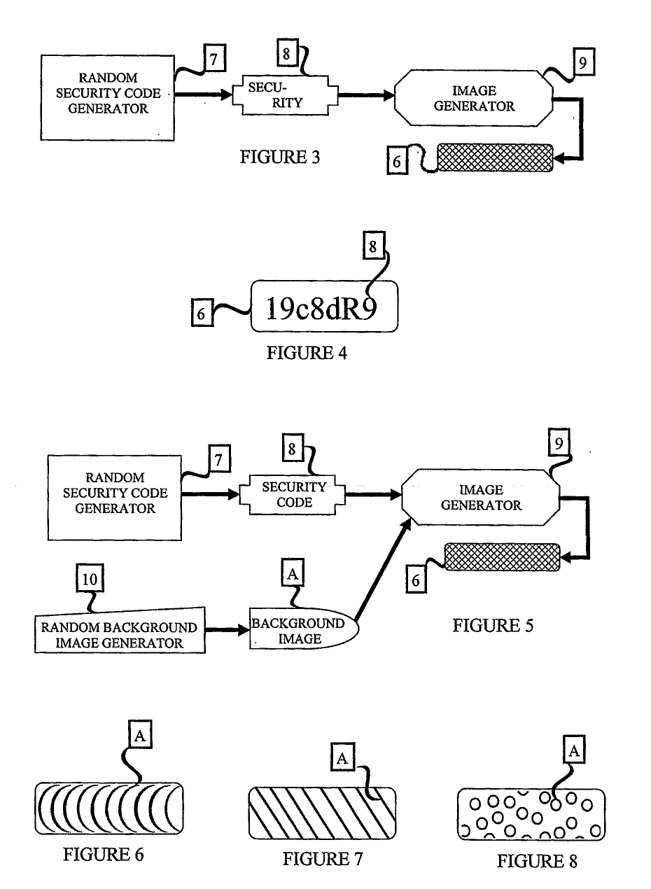

FIG. 3 is a flow diagram illustrating the operation of a User Login screen's random security code generator in accordance with an exemplary embodiment of the present invention. More particularly, FIG. 3 is a flow diagram illustrating how Screen Code Image (6) shown in FIG. 2 may be created. Referring to FIG. 3, a Random Security Code Generator (7) may generate a random Security Code (8). Security Code (8) may be automatically sent to Image Generator (9). Image Generator (9) may convert Security Code (8) into an electronic image, which is in turn sent to Screen Code Image (6) where it may be viewed by the user within Screen Shot PA as shown in FIG. 2.

FIG. 4 is a graphic representation and illustration of an exemplary code that may be produced by the Random Security Code Generator (7) illustrated in FIG. 3. More particularly, FIG. 4 is an example of a Security Code (8) that may be generated by Random Security Code Generator (7) for use in Screen Code Image (6) as illustrated in FIGS. 2 and 3.

FIG. 5 is a flow diagram illustrating an operation of an exemplary User Login screen's random security code generator coupled with an exemplary random background image generator in accordance with an exemplary embodiment of the present invention. More particularly, FIG. 5 is an exemplary flow diagram illustrating what may happen after Random Security Code Generator (7) generates a Security Code (8). After Random Security Code Generator (7) generates a Security Code (8), the Security Code (8) may be automatically sent to Image Generator (9). Either before, during, or after the generation of Security Code (8), a Random Background Image Generator (10) may generate a Background Image (A) and transmit the Background Image (A) to Image Generator (9). In an exemplary embodiment, Background Image (A) may be a randomly generated image. Image Generator (9) may combine Security Code (8) with Background Image (A) to create an exemplary Screen Code Image (6) that may be viewed by the user as shown in FIG. 2.

FIGS. 6-8 are exemplary and illustrative graphic representations of background images that may be produced by the Random Background Image Generator (10) illustrated in FIG. 5. FIG. 6 is a graphic representation of an exemplary random Background Image (A) that may be produced by the Random Background Image Generator (10) illustrated in FIG. 5. FIG. 7 is an exemplary graphic representation of another random Background Image (A) that may be produced by Random Background Image Generator (10) illustrated in FIG. 5. FIG. 8 is an exemplary graphic representation of yet another random Background Image (A) that may be produced by Random Background Image Generator (10) illustrated in FIG. 5.

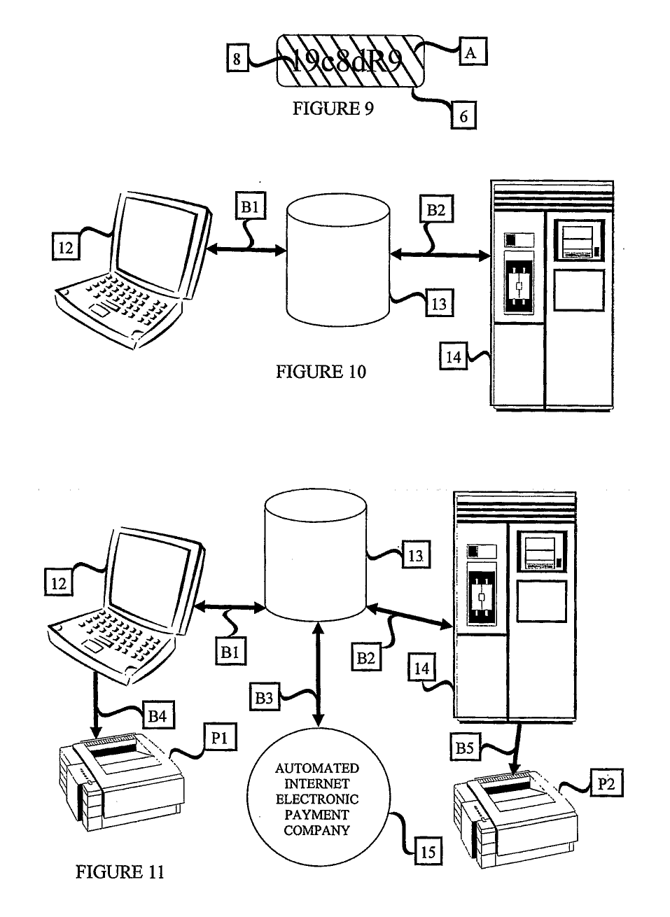

FIG. 9 is an exemplary graphic representation of Screen Code Image (6) as described in FIG. 5. More particularly, FIG. 9 is a graphic representation and illustration of an exemplary embodiment of a User Login screen's randomly generated security code (8) combined with an illustrative randomly generated background image (A) described in FIG. 5. That is, Screen Code Image (6) may comprise a combination of a random Security Code (8) and a random Background Image (A).

The use of a random security code with a random background image may be used in order to reduce the possibility of unauthorized access to the system by an unauthorized person or entity, particularly by a person or entity using an automated hacking system. The system and method may continuously alter the background image each time an authorized user logs onto the system. Continuous alteration may disable automated computer hacking programs from eliminating an image background and using Optical Character Reading (OCR) software to decipher a code.

FIG. 10 is an overview illustrating a manner in which a user may access the present invention. More particularly, FIG. 10 is a graphic illustration of an overview depicting an exemplary manner in which a user may access the present invention via, for example, an Internet Access Device (12). If, in an alternative embodiment, a communication network other than the Internet is used, a different type of access device may be used. Internet Access Device (12) may any one of many known Internet access devices or appliances. Exemplary access devices may be Microsoft Corporation's MSN TV receiver, model number RM2100, manufactured by RCA, Hitachi SH-G1000 Pocket PC Phone Edition 2002 from Sprint PCS, or other Internet connection access devices. Internet Access Devices (12) may be connected to the World Wide Web (13) or other global communication network via an Internet Connection or other Connection (B1) that may be one of many known forms such as a telephone hardwired modem, a cable TV, DSL, T1, T2, T3, wireless modem, satellite, or other available Internet connection.

In one exemplary embodiment, the invention may also use a Server (14). The invention's Server (14) may be connected to World Wide Web (13) or to another global communication network via an Internet Connection or other connection (B2). Internet Connection may be one of many known forms such as a telephone hardwired modem, cable TV, DSL, T1, T2, T3, wireless modem, satellite, or other available Internet or other connection.

A store or other seller of animals, may determine who may have access to information about an animal and the scope of such access when the store or other seller enters certain information into the system. The information that the store or seller may enter is, for example, a microchip number specific to the animal, the name and location of a breeder, the name and location of a distributor, and store identification number. The system may allow a breeder to have total access to his own records. The system may allow a Current Owner to have total access to his own records and preclude access to records after the animal is transferred to a new owner. The system may allow a Veterinarian to have total access to his own records and total access to all records pertaining to any animal the veterinarian has treated. As used herein, total access is defined as being able to view and enter data into the respective records of an animal that the Veterinarian is caring for.

The system may allow each authorized user real-time, fully secure access to information in the system about an animal. The system may only allow predetermined users and computers access to the system.

FIG. 11 is an overview illustrating a manner in which a user may access the present invention coupled to an automated electronic payment processing company or system. More particularly, FIG. 11 is an exemplary graphic illustration of an overview depicting the manner in which a user may access the present invention via the Internet Access Device (12). Internet Access Device (12) may be any one of many known Internet access devises such as Microsoft Corporation's MSN TV receiver, model number RM2100, manufactured by RCA, or Hitachi SH-G1000 Pocket PC Phone Edition 2002 from Sprint PCS, and Internet connection access devises. Internet Access Device (12) may be connected to the World Wide Web (13) via Internet Connection (B1) that may be any one of many known forms such as a telephone hardwired modem, a cable TV, DSL, T1, T2, T3, wireless modem, satellite, or other available Internet connection.

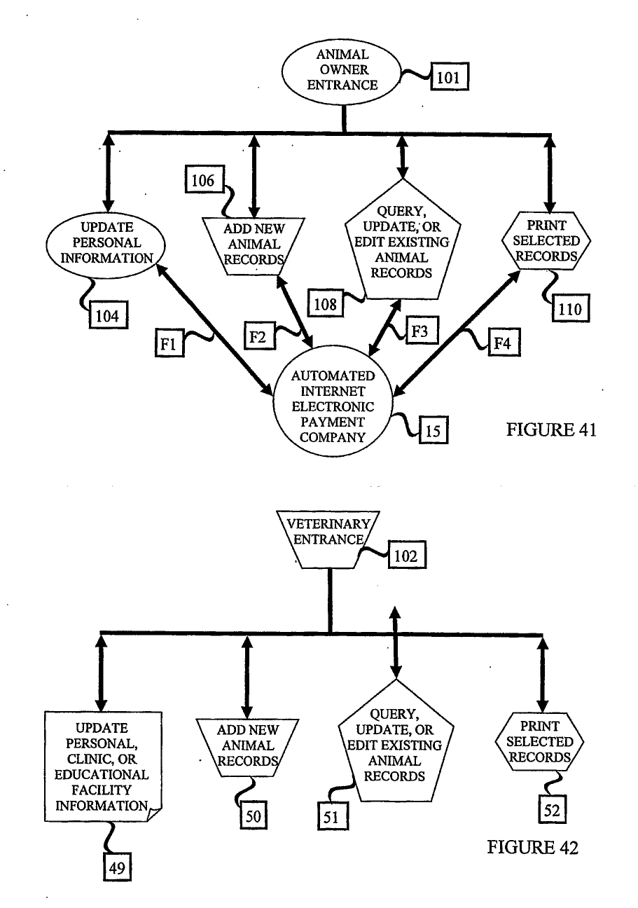

The invention's Internet Server (14) may be connected to World Wide Web (13) via Internet Connection (B2). Internet Connection (B2) may be any one of many known forms such as a telephone hardwired modem, a cable TV, DSL, T1, T2, T3, wireless modem, satellite, or other available Internet connection. An exemplary embodiment of the invention may also use an Automated Internet Electronic Payment Company (15), which may allow for paperless, electronic, and unmanned payment to the company that hosts the Internet Server (14) for services that may be performed by the company. Examples of services that may be performed by the host company are transfer of ownership, medical record update, animal identification update, filing of government forms and records, production and reproduction of ownership certificates and pedigree certificates, production of medical record history, printing of prepaid coupons, litter records, and offspring registration applications. A screen may be displayed to connect to Automated Internet Electronic Payment Company (15) when a user wants a host company to perform services for the user. Automated Internet Electronic Payment Company (15) may utilize an Internet Connection (B3) comprised of any one of many known forms of Internet access forms such as a telephone hardwired modem, cable TV, DSL, T1, T2, T3, wireless modem, satellite, or other available Internet connection. Internet Connection (B3) may connect the Automated Internet Electronic Payment Company (15) to the Internet Access Device (12) and to the Internet Server (14). Automated Internet Electronic Payment Company (15) may also be used in connection with those aspects of an exemplary embodiment of the invention illustrated in FIGS. 41, 43, and 45 and described below.

A user may also have an option of using printing capabilities. An exemplary embodiment of a user's optional printing capabilities is illustrated in FIG. 11, where Internet Access Device (12) is shown as being connected to Printer (P1) via a Printer Connection (B4). Printer Connection (B4) may be comprised of any one of many known forms of printer connections such as a parallel port cable, a serial cable, a fire-wire cable, a LAN CAT-5 cable, a wireless broadband router signal, or other available printer connection. Similarly, a company hosting the Internet Server (14) may also have optional printing capabilities as illustrated in FIG. 11. As shown in FIG. 11, Internet Server (14) may be connected to a Printer (P2) via a Printer Connection (B5). Printer Connection (B5) may be comprised of any one of many known forms of printer connections such as a parallel port cable, a serial cable, a fire-wire cable, a LAN CAT-5 cable, a wireless broadband router signal, or other available printer connection. For example a hosting company or a store may use Printer (P1) or Printer (P2) to print prepaid stickers which a customer may later use to pay for services and products.

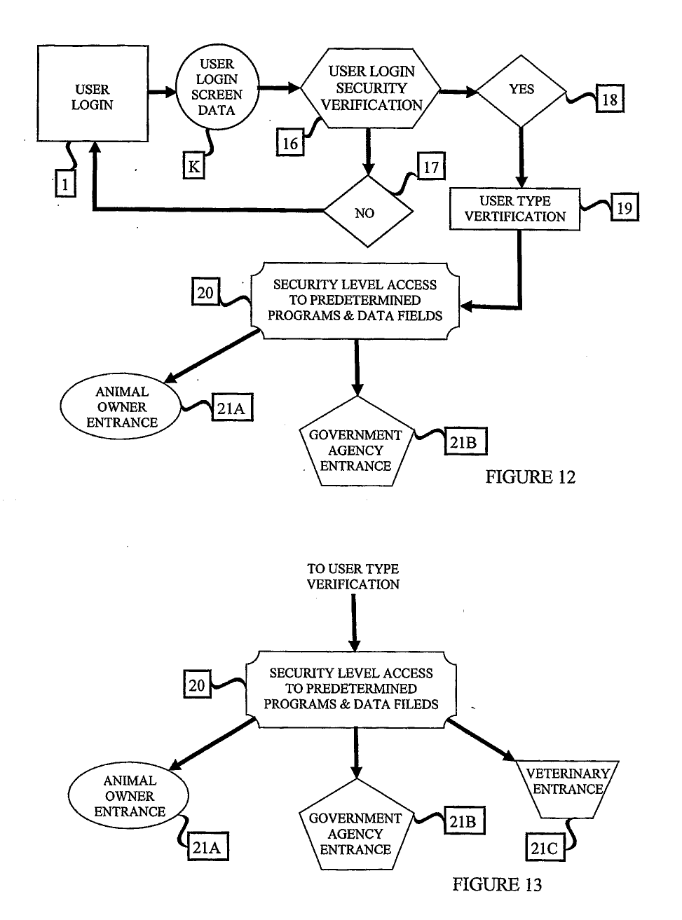

FIG. 12 is an exemplary flow diagram illustrating a User Login screen's security logic features coupled with an ability to sort and direct users to predetermined security levels and applications in accordance with an exemplary embodiment of the present invention. More particularly, FIG. 12 illustrates a logic flow of part of an exemplary embodiment of the present invention's method. In FIG. 12, data shown in Screen Shot 1A is identified as User Login Screen Data (K). Referring to FIG. 12, after there is User Login (1), User Login Screen Data (K) may be transmitted to a User Login Security Verification (16). In Decision Block 16, the invention determines if the User Login Screen Data (K) matches predetermined data that is stored on Internet Server (14). If there is a match, as illustrated by Yes (18), User Login Security Verification (16) queries Internet Server (14) for User Type Verification (19). User Type Verification (19) allows the present invention to direct the user to a predetermined computer application that is stored on Internet Server (14). A number of predetermined computer applications may be stored on Internet Server (14) that are specific for the needs of different classifications of users. These applications are illustrated by Security Level Access To Predetermined Data Fields (20). Illustrations of examples of two such user types are shown in FIGS. 12 and 13 as an Animal Owner Entrance (21A) and Government Agency Entrance (21B), respectively.

Alternatively, if the User Login Screen Data (K) does not match the predetermined data stored on Internet Server (14), the answer to Decision Block 16 would be No (17). Under that condition, the user would be prohibited from electronically entering the Internet Based Server (14) and would be routed back to the original User Login (1).

FIG. 13 is an exemplary flow diagram illustrating an ability to sort and direct users to predetermined security levels and applications in accordance with an exemplary embodiment of the present invention. More particularly, FIG. 13 shows an exemplary flow chart of an exemplary logic method for coupling different kinds of users to the invention's system. In this exemplary illustration, Security Level Access To Predetermined Programs & Data Fields (20) illustrates three exemplary user type entrances: an Animal Owner Entrance (21A), a Government Agency Entrance (21B), and a Veterinary Entrance (21C). That is, the system may be accessed by the authorized owner of an animal, by an authorized government agency, or by an authorized veterinary user. In other exemplary embodiments, other types or classes of users may also be authorized to access the system.

It will be understood that the system components and the people who use the system may be located in different parts of the world. For example, and for illustration purposes only, Animal Owner Entrance (21A) may be in a country other than the United States, Government Agency Entrance (21B) may be in Texas in the United States, Veterinary Entrance (21C) may be in New Jersey in the United States, and Internet Server (14) may be in Pennsylvania in the United States. It will also be understood that all of these components and people who use the system may be located in the same State and Country.

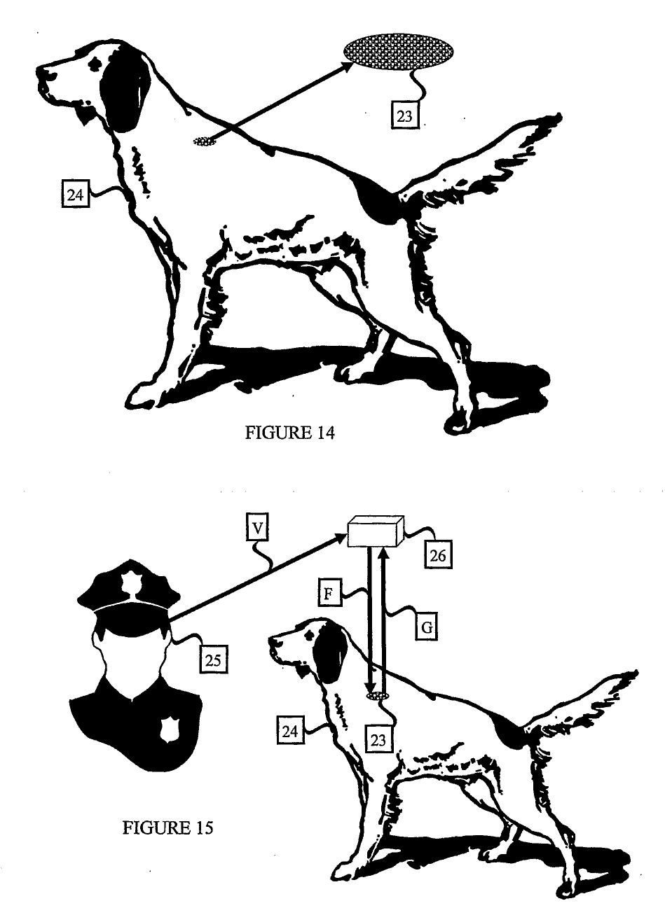

FIG. 14 is a graphic representation of an animal that carries a microchip used for unique identification. More particularly, FIG. 14 is a graphic representation illustrating an exemplary use of a Microchip (23) that is affixed on, in, or under the skin of an Animal 24. The broad use of microchips in animals is well known and is thus not further described herein. Microchips can be obtained through most veterinary supply companies and are manufactured by companies such as AVID Identification Systems, Inc. of Folsom, La.

FIG. 15 is a graphic representation of an exemplary method showing how a government representative may acquire the microchip identification number of an animal using a universal or other microchip scanner. More particularly, FIG. 15 is a graphic representation illustrating how a Government Representative (25) may utilize a Microchip Scanner (26) to transmit a Signal (F) to energize Microchip (23). In an exemplary embodiment, Government Representative (25) may activate or couple Microchip Scanner (26) over a wireless connection (V). The wireless connection may be implemented over a Global Information Network such as the Internet. Once energized, Microchip (23) may emit a separate signal (G) that may be received and displayed by Microchip Scanner (26). Microchip Scanner (26) may be a transceiver. An example of Microchip Scanner (26) is Model Power Tracker II, manufactured by AVID Identification Systems, Inc. of Folsom, La. Once obtained, the microchip information may be provided by Government Representative (25) to the exemplary system and information pertaining to animal 24 may then be accessed by Government Representative (25). This information may include for example, owner information, animal medical history, etc.

Although microchip identification is described above the invention is not so limited in that other means may be used to identify a particular animal, such as the below non-limiting illustrated examples.

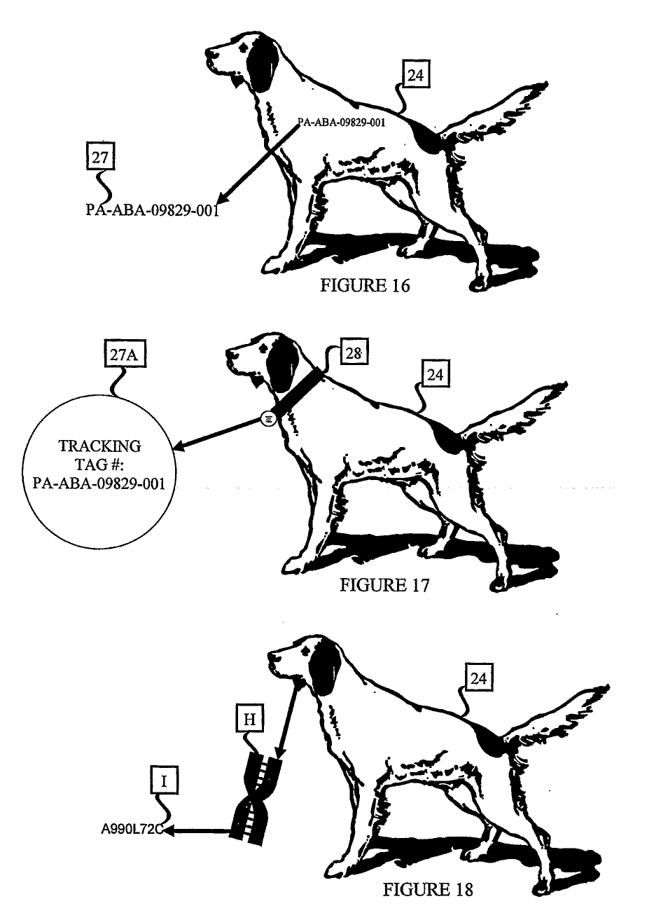

FIG. 16 is a graphic representation of an animal that has an illustrative tattoo that may be used for unique identification. More specifically, FIG. 16 is an illustration of an exemplary embodiment of how the present invention may use a unique Tattoo Identification Number (27) that may be permanently embedded into the skin of Animal (24).

FIG. 17 is a graphic representation of an animal that has a tag attached to its collar for unique identification. More specifically, FIG. 17 is an illustration of an exemplary embodiment of how an exemplary embodiment of the present invention may use a unique Identification Tag (27A) that may be affixed to Animal (24) via a Collar (28).

FIG. 18 is a graphic representation of an animal's DNA sample used for unique identification. More specifically, FIG. 18 is an illustration of an exemplary embodiment of how an exemplary embodiment of the present invention may use a unique DNA Identification Tracking Number (I) issued by a DNA testing company such as HealthGene Molecular Diagnostic and Reasearch Center, 2175 Keele St., Toronto, ON, Canada M6M 3Z4 after a DNA Sample (H) has been obtained from Animal (24).

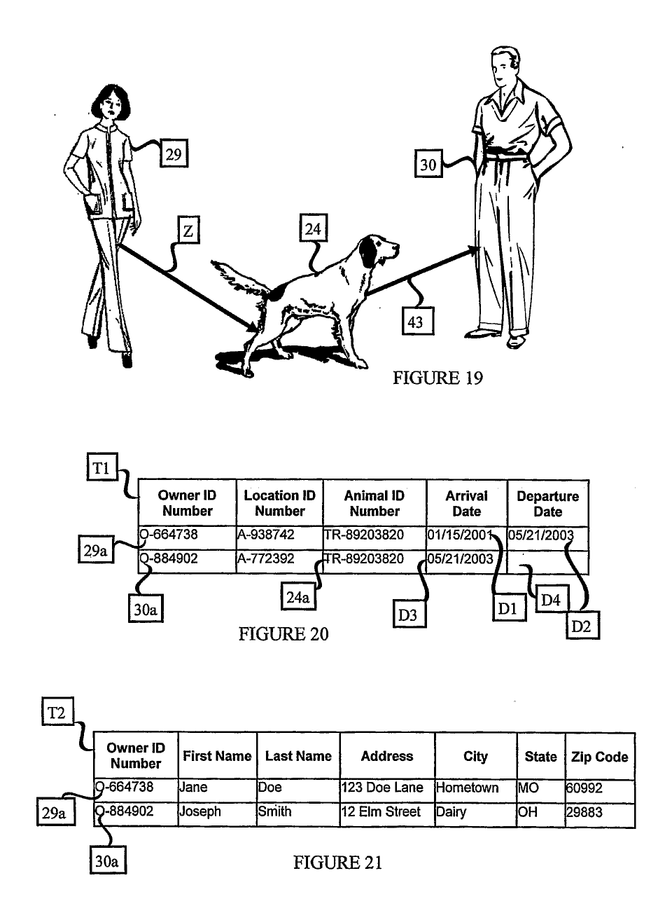

Referring now to FIG. 19, a graphic representation of a transfer of ownership of an animal is illustrated. More specifically, FIG. 19 is a graphic representation of Original Animal Owner (29) transferring ownership of Animal (24) to Current Animal Owner (30). It will be understood that reference number (29) may also refer to a Previous Owner. It will also be understood that reference number (30) may also refer to a New Owner. There may be only one Original Owner; but there may be more than one Previous Owner. Similarly, there may be more than one New Owner; but there may be only one Current Owner. It will also be understood that FIG. 19 may illustrate other transfers of an animal. For example, it may illustrate the transfer of an animal by a broker from one kennel to another kennel.

The present invention's computer system utilizes a database of multiple indexed tables. This use of indexed tables allows for a significant reduction in the overall size of the database and a greatly enhanced operating and computing speed. Each indexed table may store a respective datum about an animal and all people and entities who contact the animal. FIG. 20 is an illustration of an indexed ownership table of an animal that may be used in accordance with an exemplary embodiment of the present invention. More specifically, FIG. 20 is an illustration of an Indexed Ownership Table (T1). In Indexed Ownership Table (T1), illustrative Owner ID Number (29a) represents a unique identification number that may be used to identify Original Animal Owner (29). Likewise, illustrative Owner ID Number (30a) represents a unique identification number that may be used to identify Current Animal Owner (30). Illustrative Animal ID Number (24a) represents a unique identification number that may be used to identify Animal (24).

Illustrative Arrival Date (D1) in FIG. 20 illustrates a date that may be stored in the invention's database to record the beginning date when Original Owner (29) commenced ownership of Animal (24). Illustrative Departure Date (D2) illustrates a date that may be stored in the invention's database to record the ending date when

Original Owner (29) ceased ownership of Animal (24). Illustrative Arrival Date (D3) illustrates a date that may be stored in the invention's database to record the beginning date when Current Owner (30) commenced ownership of Animal (24). In the illustrative table shown in FIG. 20, illustrative date D2 is the same as illustrative date D3. However, dates D2 and D3 need not be the same date. A Departure Date (D4) illustrates a date that may be stored in the invention's database to record the ending date when Current Owner (30) ceased ownership of Animal (24). In FIG. 20, Departure Date (D4) field is empty illustrating that Current Owner (30) still owns Animal (24). A departure date as listed in table T1 without a subsequent Arrival Date may be indicative of the animal's death or other loss. In an alternative embodiment of FIG. 20, dates may be entered when someone other than an Owner possesses an animal.

Information may be entered into Indexed Ownership Table (T1) by an Original Owner (29) and by a Current Owner (30). When Current Owner purchases an animal, Current Owner becomes Original Owner, etc. Once an Owner (whether an Original Owner or a Current Owner) enters a Departure Date for an animal, the Owner who enters the Departure Date is precluded by the system from editing records pertaining to that animal and is precluded from retrieving new information about the animal that is entered into the system after the entry of the Departure Date information. The transferring Owner gives the New Owner a new internet access number. The New Owner may then confirm the Old Owner's departure information using the new internet access number.

FIG. 21 is an illustration of an indexed owner's address table in accordance with an exemplary embodiment of the present invention. More specifically, FIG. 21 illustrates that an exemplary embodiment of the invention's database may record a physical home address of an owner even though the owner's physical address may be different than the animal's physical address. Table (T2) accordingly is another example of an indexed table that may be used as part of the invention. Illustrative Animal Owner's Address Table (T2) may index and link the name and home address of an Original Animal Owner (29) with an Original Animal Owner ID Number (29a). Likewise, the name and address of a Current Animal Owner (30) may be indexed and linked to a Current Animal Owner ID Number (30a). In exemplary Table (T2), the first and last names of Original Animal Owner (29) are identified as Jane Doe; the address of Original Owner 29 is identified as 123 Doe Lane, Hometown, Mo. 60992. Exemplary Table (T2) identifies the first and last names of Current Animal Owner (30) as Joseph Smith; the address of Current Animal Owner (30) is identified as 12 Elm Street, Dairy, Ohio 29883. In an alternative embodiment, FIG. 21 may identify the names and addresses of people other than an Owner who may possess an animal.

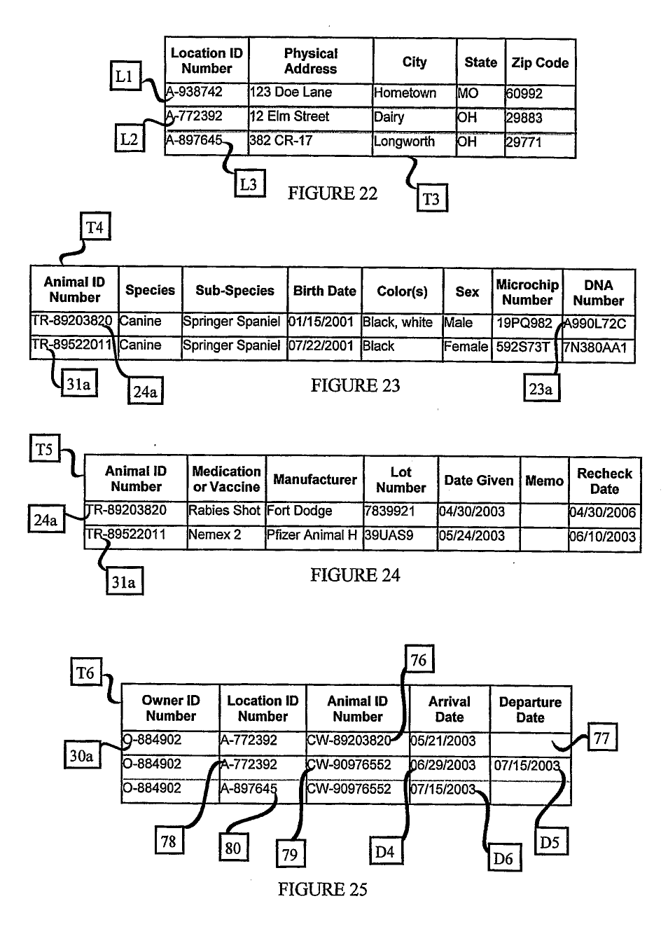

FIG. 22 is an illustration of an indexed facility location address table in accordance with an exemplary embodiment of the present invention. More specifically, FIG. 22 illustrates that the invention's database may record an animal's physical address if it is the same as the animal owner's home or other address or if it is different than the animal owner's home or other address. Animal's Physical Address Table (T3) is another example of an indexed table. Animal's Physical Address Table (T3) allows for the input of one or more physical location sites of Animal (24). Location ID Number (L1), Location ID Number (L2), and Location ID Number (L3) are all examples of different location sites that may be indexed within an exemplary embodiment of the present invention's computer system. In addition to each Location ID Number Table T3 may also include the physical address, city, state, and zip code associated with each Location ID Number.

FIG. 23 is an illustration of an indexed identification table of an animal in accordance with an exemplary embodiment of the present invention. More specifically, FIG. 23 illustrates that the invention's database may store an animal's species, sub-Species, Birth Date, color(s) Sex, Microchip Number (23a), DNA Number, and other information of the animal that a user of the system wishes to enter in the animal's record. Animal Information Table (T4) is an example of data that may be associated with Animal ID Number (24a) and Animal ID Number (31a). For example, Animal Information Table (T4) illustrates that an animal with illustrative Animal ID Number TR-89203820 may be a black, white male canine, Springer Spaniel, having an illustrative birth date of Jan. 15, 2001. It has been assigned an illustrative Microchip Number 19PQ982 and an illustrative DNA Number A990L72C. Similarly, Animal Information Table (T4) illustrates that the animal with illustrative Animal ID Number TR-89522011 may be a black female canine, Springer Spaniel, having an illustrative birth date of Jul. 22, 2001. It has been assigned an illustrative Microchip Number 592S73T and an illustrative DNA Number 7N380AA1.

FIG. 24 is an illustration of an indexed veterinary health record table of an animal in accordance with an exemplary embodiment of the present invention. More specifically, FIG. 24 illustrates that the invention's database may store an animal's medical data such as medications or vaccines that have been administered to the animal and other information about the medication or vaccine including information such as the manufacturer of the medication or vaccine, the lot number, the date it was given to the animal, the date when the animal should be rechecked for possible re-medication or re-vaccination, and other information of the animal that the user of the system wishes to enter in the animal's record. Illustrative Medical Record Table (T5) is an illustration of medical data that may be associated with illustrative Animal ID Number (24a) and illustrative Animal ID Number (31a). As an illustration, FIG. 24 shows that the animal with Animal ID Number TR-89203820 had a rabies shot on Apr. 30, 2003. The rabies vaccine was manufactured by Fort Dodge and was from Lot Number 7839921. The animal is to be rechecked on Apr. 30, 2006. As another illustration, FIG. 24 shows that the animal with illustrative Animal ID Number TR-89522011 was given Nemex 2 medication on May 24, 2003. The medication was manufactured by Pfizer Animal H and was from Lot Number 39UAS9. The animal is to be rechecked on Jun. 10, 2003. Although no information is contained in either “Memo” column, additional medical information may be placed there, as desired.

FIG. 25 is an illustration of an indexed animal owner table that may be used to show multiple animals owned at different locations in accordance with an exemplary embodiment of the present invention. More specifically, FIG. 25 illustrates that the invention's database may store information about all of the animals that may be owned by a single user at multiple transfer locations. Owner/Animal/Location Table (T6) illustrates that the owner assigned to illustrative Owner ID Number (30a) O-884902 has recorded into the invention's database two separate locations areas. The invention's database may create and store a unique indexed Location ID Number for each location as represented by Location ID Number (78) and Location ID Number (80).

Owner/Animal/Location Table (T6) shows the historical and chronological location of animals. For example, illustrative Animal ID Number (79) arrived at Location ID Number (78) on illustrative Arrival Date (D4) and was subsequently transferred by illustrative Owner ID Number (30a) on illustrative Departure Date (D5), creating an illustrative Arrival Date (D6) at illustrative Location ID Number (80). In the example illustrated in FIG. 25, Arrival Date (D6) is the same date as Departure Date D5. However, the two dates need not be the same. Owner/Animal/Location Table (T6) also shows location information and other information for another animal identified with illustrative Animal ID Number CW-89203820. In another embodiment, Table (T6) may provide information about any number of animals.

FIG. 26 is an illustration of an indexed contagious disease-tracking table of an animal that may be used in accordance with an exemplary embodiment of the present invention. More specifically, FIG. 26 illustrates that the invention's database may record and track disease information about an animal about which information is contained in the system. Disease Tracking Table (T7) identifies an animal with illustrative assigned Animal ID Number (81) as having illustrative Disease Name (82) with illustrative Symptoms Shown (83). The illustrative Vet ID Number (84) is indexed to the veterinarian, clinic, or educational facility that has diagnosed the animal's disease on illustrative Date of Examination (85).

After information is entered into the system and tables are created, a user may track information about an animal by searching the system's database. For example, by entering an animal's microchip number, a user may determine the name, breed, whelping date, sex, colors and owner information about the animal such as the owner's name, address, and telephone number. Similarly, a veterinarian or a Government Agency may track the health and disease information about an animal.

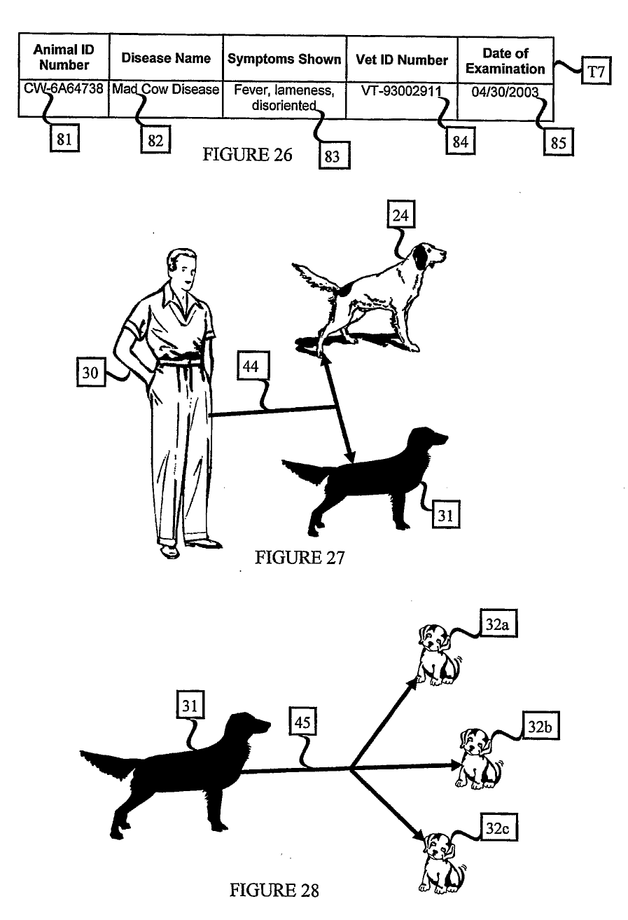

FIG. 27 is a graphic representation of an owner of an animal initiating the breeding of a male and female to produce offspring. More specifically, FIG. 27 is a graphic representation of an Animal Owner (30) initiating the Breeding (44) of male Animal (24) to female Animal (31) for purposes of procreation.

FIG. 28 is a graphic representation of a female animal producing offspring after being bred. More specifically, FIG. 28 is a graphic representation of female Animal (31) subsequently Giving Birth (45) to Offspring (32a), Offspring (32b), and Offspring (32c). This number of offspring many range from one to the maximum number any one female species of animal may produce.

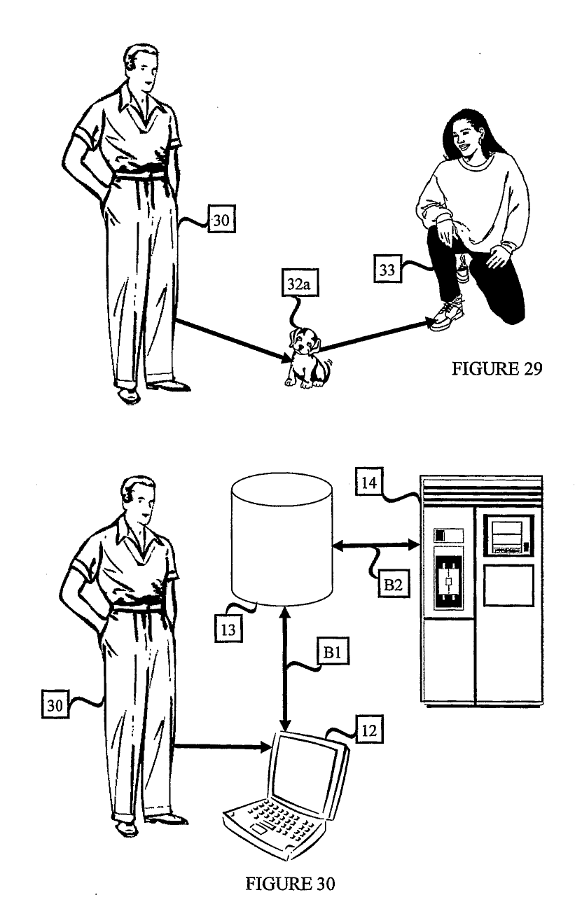

FIG. 29 is a graphic representation of a transfer of ownership of an animal's offspring to a new owner. More specifically, FIG. 29 is a graphic representation of Animal Owner (30) transferring ownership of Offspring (32a) to Offspring Owner (33).

FIG. 30 is a graphic overview flow chart illustrating a manner in which an animal's owner who is a breeder may use the present invention. More specifically, FIG. 30 is an overview illustrating the manner in which Animal Owner (30) who is a breeder may use the present invention. As shown in FIG. 30, Animal Owner (30) may utilize Access Device (12) to access World Wide Web (13) via Internet Connection (B1). World Wide Web (13) may be connected to Internet Server (14) via Internet Connection (B2). By placing information into tables such as Tables (T1) to (T7), Animal Owner (30) may record breeding information, offspring birth information, medical information, microchip numbers, tattoo numbers, ownership transfer information, and other information about animals that are owned by Animal Owner (30).

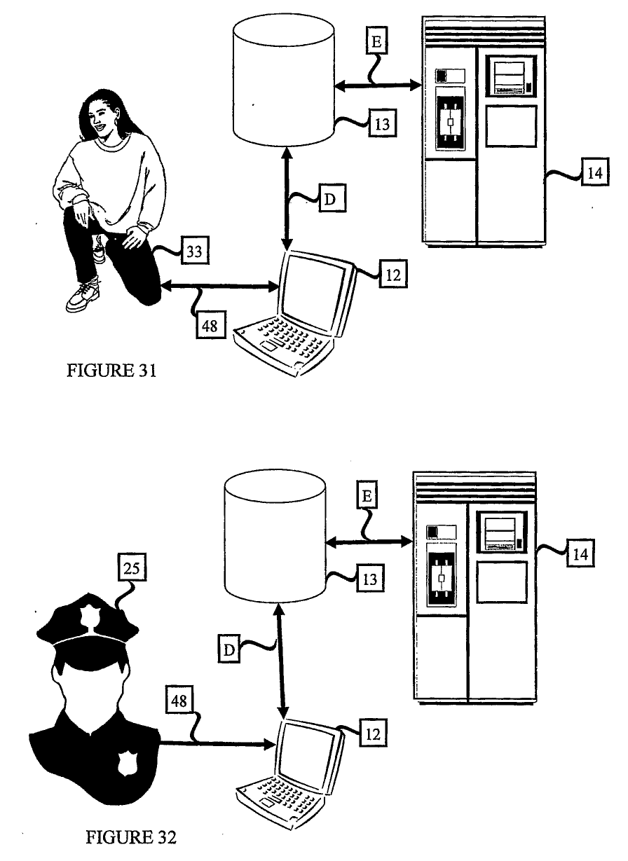

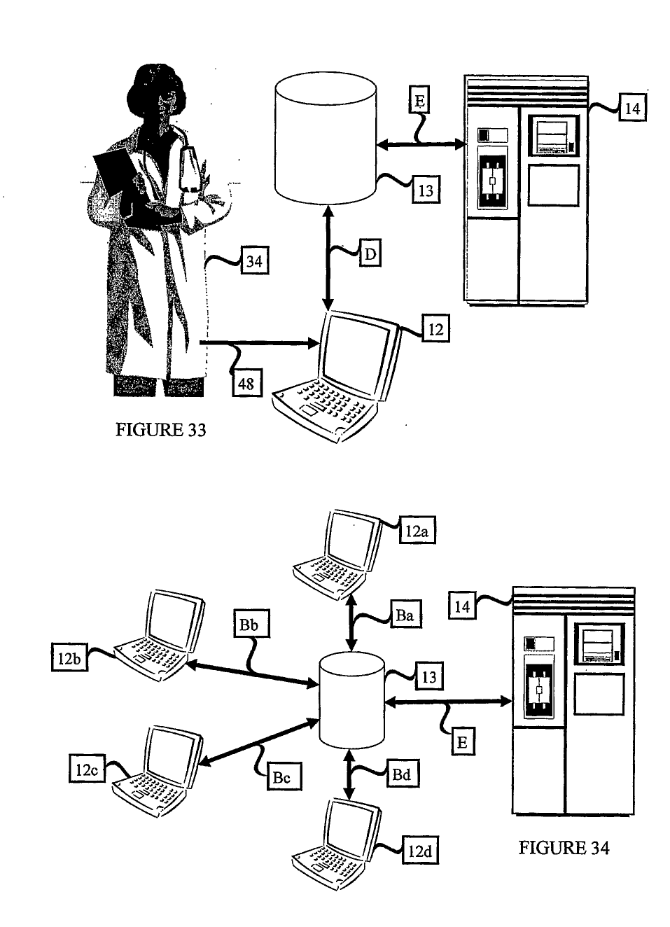

FIG. 31 is a graphic overview illustrating a manner in which a new owner of offspring from an animal may use an exemplary embodiment of the present invention. More specifically, FIG. 31 is an overview illustrating the manner in which Offspring Owner (33) who is a new owner of an animal may use the present invention. Offspring Owner (33) may utilize Access Device (12) to access World Wide Web (13) via Internet Connection (B1). World Wide Web (13) may be connected to Internet Server (14) via Internet Connection (B2). By placing information into tables such as Tables (T1) to (T7), Offspring Owner (33) may record animal information, ownership transfer information, and other information about animals that are owned by Offspring Owner (33).

FIG. 32 is a graphic overview illustrating a manner in which a government representative may use an exemplary embodiment of the present invention. More specifically, FIG. 32 is an overview illustrating the manner in which a Government Representative (25) may use the present invention. Government Representative (25) may utilize Access Device (12) to access World Wide Web (13) via Internet Connection (B1). World Wide Web (13) may be connected to Internet Server (14) via Internet Connection (B2). The procedures described above allow Government Representative (25) to have ready access to predetermined records and data fields pertaining to animals whose data has been recorded in the system. The information be used to verify compliance with regulatory laws such as state or federal inspections required by the Department of Agriculture or to identify a lost or stolen animal. The system may allow a Government Representative to review a specific number of records with a specific period of time. The system may track a Government Representative's access to records in the system. If a Government Representative accesses a predetermined number of records within a predetermined period of time, the system may prevent that Government Representative from accessing additional records. The purpose of the prevention feature of the system is to protect against the possibility that an unauthorized person might break into the system using a Government's Representative's access information.

FIG. 33 is a graphic overview illustrating a manner in which a veterinarian may use an exemplary embodiment of the present invention. More specifically, FIG. 33 is an overview illustrating the manner in which a Veterinary Representative (34) may use the present invention. Veterinary Representative (34) may utilize Access Device (12) to access World Wide Web (13) via Internet Connection (B1). World Wide Web (13) may be connected to Internet Server (14) via Internet Connection (B2). The procedures and tables described above may allow Veterinary Representative (34) to have ready access to predetermined records and data fields of animals about which information is stored in the system's database. The stored information may be used, for example, for updating veterinary health records, or in conjunction with government agencies to determine the source of diseased or infected animals and to determine if they have had contact with other animals or animal colonies. The system may allow a veterinarian to review a specific number of records with a specific period of time. The system may track a veterinarian's access to records in the system. If a veterinarian accesses a predetermined number of records within a predetermined period of time, the system may prevent that veterinarian from accessing additional records. The purpose of the prevention feature of the system is to protect against the possibility that an unauthorized person might break into the system using a veterinarian's access information.

FIG. 34 is a graphic overview illustrating a manner in which multiple users may access an exemplary embodiment of the present invention. More specifically, FIG. 34 is an overview illustrating the manner in which multiple access devices may simultaneously access the present invention. Internet Access Device (12a) may access World Wide Web (13) via Internet Connection (Ba). Internet Access Device (12b) may access World Wide Web (13) via Internet Connection (Bb). Internet Access Device (12c) may access World Wide Web (13) via Internet Connection (Bc). Internet Access Device (12d) may access World Wide Web (13) via Internet Connection (Bd). World Wide Web (13) may connect Server (14) via Internet Connection (E) to some or all of the Internet Access Devices.

FIG. 34 illustrates that multiple authorized users may access information in an exemplary embodiment of the present invention about the same animal simultaneously. FIG. 34 illustrates, for example, that authorized private individuals, authorized corporations, authorized veterinarians, and authorized government representatives may all be able to access the same information about the same animal simultaneously. However, the system may limit the information that is available to each of them. That is, the system may grant each of them a different level of access. For example, a government representative may have access to a first scope of information in order to conduct a government audit, for example, to track mad cow disease. A farmer may have a different, more limited, scope of access to information that may enable the farmer to identify his cattle. A store, or other distributor may have still another limited scope of access to information that may enable the store or other distributor to retrieve breeding and health information about animals at the store or other distributor that are available for sale.

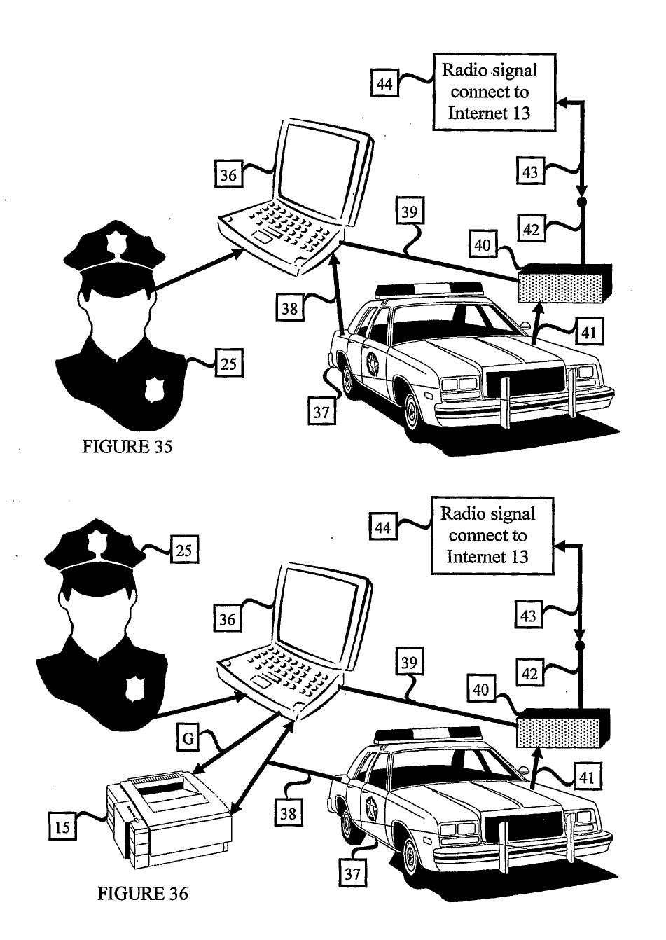

FIG. 35 is a graphic exemplary overview illustrating a manner in which a government representative may use a wireless mobile method to access predetermined computer programs, processes, and data fields of an exemplary embodiment of the present invention. More specifically, FIG. 35 is a graphic exemplary overview illustrating the manner in which a government representative may utilize a wireless, mobile connection with an exemplary embodiment of the present invention. Government Representative (25) may access the present invention via Mobile Internet Access Terminal (36). In an exemplary embodiment, Mobile Internet Access Terminal (36) may be powered by an electrical system of vehicle (37) via a Power Connection (38). In an alternative embodiment, Mobile Internet Access Terminal (36) may be powered by another source of power. Wireless Modem (40) may powered by an electrical system of Vehicle (37) via Power Connection (41). In an alternative embodiment, Wireless Modem (40) may be powered by another source of power. Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that may be connected to World Wide Web (13).

FIG. 36 is a graphic exemplary overview illustrating a manner in which a government representative may use a wireless mobile method to access predetermined computer programs and data fields coupled with a printer of an exemplary embodiment of the present invention. More specifically, FIG. 36 is a graphic exemplary overview illustrating the manner in which a government representative may utilize a wireless mobile use of the present invention. Government Representative (25) may access the present invention via Mobile Internet Access Terminal (36). In an exemplary embodiment, Mobile Internet Access Terminal (36) may be powered by the electrical system of Vehicle (37) via Power Connection (38). Also in an exemplary embodiment, Wireless Modem (40) may be powered by the electrical system of Vehicle (37) via Power Connection (41). In an alternative embodiment, Mobile Internet Access Terminal (36) and/or Wireless Modem (40) may be powered by at least one different source of power. Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that is connected to World Wide Web (13). Additionally, Printer (15) may be powered by Power Connection (38) and receive data for printing forms and documents from Mobile Internet Access Terminal (36).

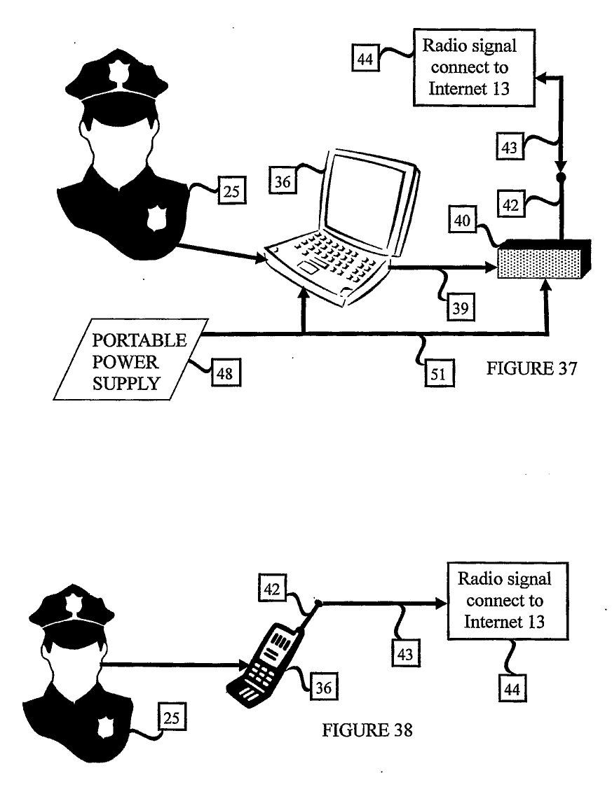

FIG. 37 is a graphic exemplary overview illustrating a manner in which a government representative may use a wireless mobile method to access predetermined processes and data fields coupled with a portable battery supply or other power supply of an exemplary embodiment of the present invention. More specifically, FIG. 37 is a graphic exemplary overview illustrating the manner in which a government representative may utilize a more portable wireless mobile use of the present invention. Government Representative (25) may access the present invention via Mobile Internet Access Terminal (36). Mobile Internet Access Terminal (36) and Wireless Modem (40) may be powered by Portable Power Supply (48) via Power Connection (51). Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that may be connected to World Wide Web (13).

FIG. 38 is a graphic exemplary overview illustrating a manner in which a government representative may use a wireless mobile method to access predetermined processes and data fields of an exemplary embodiment of the present invention. More specifically, FIG. 38 is a graphic exemplary overview illustrating the manner in which a government representative may utilize a highly portable and lightweight wireless mobile use of the present invention. Government Representative (25) may access the present invention via Mobile Internet Access Terminal (36). Said Mobile Internet Access Terminal (36) may be a PDA or cell phone such as the Hitachi SH-G1000 Pocket PC Phone Edition 2002 from Sprint PCS. Wireless Modem (40) may be powered by Portable Power Supply (48) via Power Connection (51). Mobile Internet Access Terminal (36) may utilize Antenna (42) to receive and transmit Signal (43) to Internet Antenna Transceiver (44) that may be connected to World Wide Web (13).

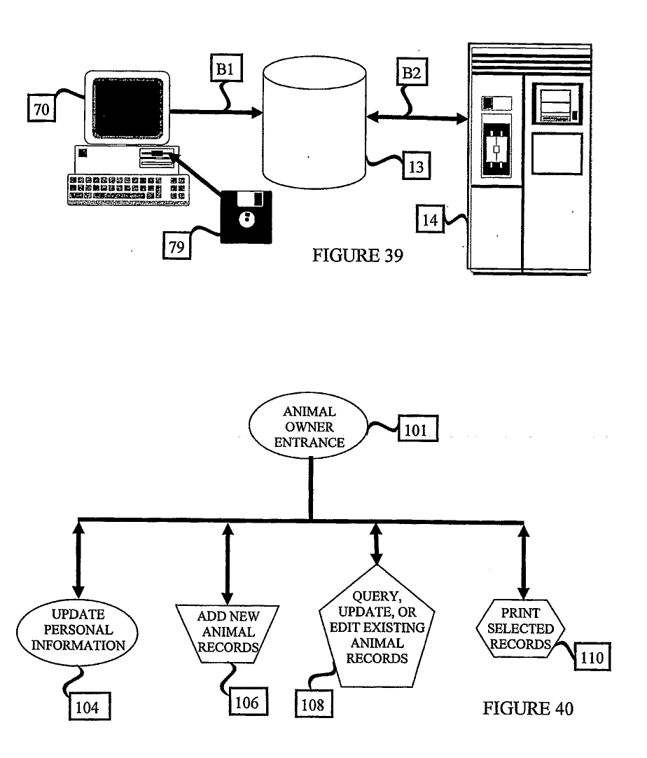

FIG. 39 is a graphic exemplary overview illustrating how an exemplary embodiment of the present invention may be coupled to a user data storage device allowing a user to store a copy of the user's data at the user's location. More specifically, FIG. 39 is a graphic exemplary overview illustrating how the present invention may be coupled to a user data storage device allowing the user to store a copy of the user's data at the user's location. Data stored on Server (14) may be downloaded via Internet Connection (B2) through World Wide Web (13). Internet Access Device (70) may utilize Internet Connection (B1) to complete the download process for storage into a medium such as a Diskette (79). Additional well known storage media may also include, but not be limited, to a burnable CD, a computer hard drive, or a flash memory such as the Viking Flash Memory 128 MB Card manufactured by Viking Components, 30200 Avenida de las Banderas, Rancho Santa Margarita, Calif. 92688, USA.

FIG. 40 is a flow diagram illustrating how an animal owner may access and use predetermined, exemplary, functions in accordance with an exemplary embodiment of the present invention. More specifically, FIG. 40 is a flow chart showing Animal Owner Entrance (101) that allows the animal owner user to transfer information and data between different predetermined applications of the present invention. Option (104) allows the user to update personal information such as name, address, phone number, e-mail address, and other information about the user. Option (106) allows the user to add new animal records to the system. Option (108) allows the user to query, update, or edit existing animal records. Option (110) allows the user to print selected records such as required government forms, medical records, bills of sale, and other historical information maintained in the database of the system.

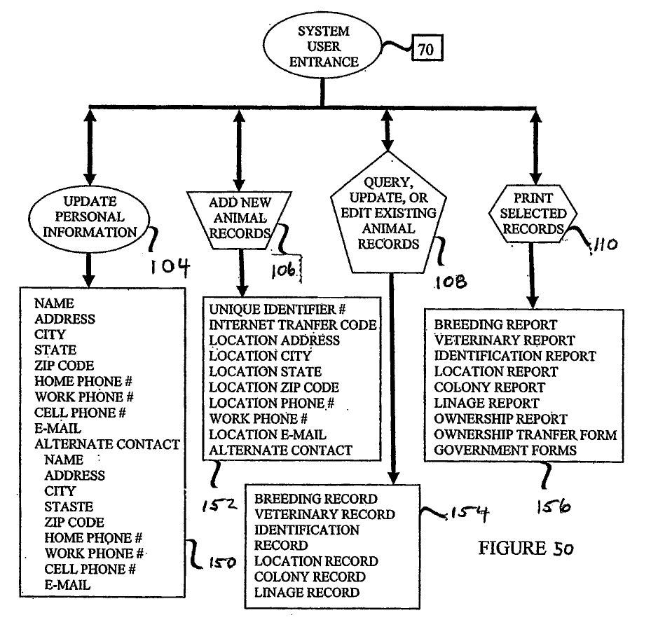

FIG. 50 is a flow diagram illustrating exemplary information that may be entered into, stored in, retrieved from, and determined from the system by a user of the system in accordance with an exemplary embodiment of the present invention. The processes illustrated in FIG. 50 may be used by a user who has access to the system; for example, an owner, a breeder, a government representative, a veterinarian, or other authorized users. Option 104 illustrates identifying personal information about the persons who may use the system. Option 106 illustrates identifying information that may be entered into the system about animals that may be registered in the system. Option 108 illustrates other information that may be retrieved from the system. Option 110 illustrates information that may be retrieved from the system via a printed record.

Table 150 illustrates information that the user may enter, store, retrieve, and determine in Option (104). For example, the user may determine or correct information about the current owner, such as name, address, city, state, zip code, home telephone number, work telephone number, cellular telephone number, e-mail address. Using Option (104), the user may also enter, store, retrieve, and determine alternative contact information such as name, address, city, state, zip code, home telephone number, work telephone number, cellular telephone number, and e-mail address. When the user is a current Animal Owner, the current Animal Owner may determine the same information about all prior owners of the animal.

Table 152 illustrates information that a user, such as a current Animal Owner, may determine from using Option (106). For example, a current Animal Owner may determine the unique identifier assigned to an animal, an internet transfer code, a current location address of an animal, including city, state, zip code, phone number, work telephone number of a person connected to the animal, an e-mail address at the animal's location, and alternate contact information for the animal.

Table 154 illustrates the kind of summary information that a current Animal Owner or other user may obtain by using Option (108). For example, by querying the database, the current Animal Owner or other authorized user may obtain the animal's historical breeding record. An historical breeding record may include such information as the breeding dates and Animal ID Numbers of animals bred to the animal, whether the breeding was performed naturally or artificially, if the breeding was successful, the number and sex of the offspring, the location of the birth or whelping took place. The current Animal Owner or other authorized user may also obtain the animal's historical veterinary record. An historical veterinary record may include such information as the names and addresses of all veterinarians who have examined or treated the animal, the nature of the treatments rendered to the animal, any diseases treated, and any medications prescribed or administered by each veterinarian. The current Animal Owner or other authorized user may also obtain the animal's identification record. This information may include information about unique identification of the animal such as microchip number, tag number, registration number, tattoo number, color and markings, lineage and birth date.

Option (108) may also be used to add a new breeder and distributor to a kennel. It may also be used by a pet store to view reports used by the pet store.

Table 154 also illustrates that the current Animal Owner may add, store, retrieve, and determine location information pertaining to his own ownership. However, the current Animal Owner may not edit certain previously entered information, such as a previous owner's location information. Table 154 also illustrates that the current Animal Owner or other user may determine the location record of the animal. More specifically, this information may include each location, including name and address, where the animal has been located from birth to the date of inquiry. Table 154 also illustrates that the current Owner or other user may determine colony information about an animal. That is, the current Owner or other user may determine the identity of every other animal that was in the same location as the animal in question. The availability of a colony record may allow the current Animal Owner or other user such as a Government Agency to identify potentially infected animals for quarantine. Table 154 may also allow the current Animal Owner or other user to determine a lineage record about the animal. A lineage record may provide information about physical characteristics and medical history of the animal's ancestry. A lineage record differs from a breeding record in that the breeding history includes breeding that may have not resulted in the procreation of offspring.

Table 156 illustrates the kinds of information that may be printed by the current Animal Owner or other user. Table 156 shows that the current Animal Owner or other user may print all of the information that may be determined in Table 154. In addition, the current Animal Owner or other user may also print ownership transfer forms and government agency forms. A store may also use Tables 154 and 156 to retrieve and print reports that may be useful to the store such as sales analysis reports, warranty information, veterinary health certificates, and types of animals for sale. It will be understood that access to Table 156 may be limited by the scope of access granted to the user.

Although the information illustrated in FIG. 50 and Tables 150-156 may be determined by an Animal Owner, it will be understood that the information may also be retrieved and determined, retrieved, and printed by a veterinarian and/or by a government agency. For example, Department of Agriculture forms may be retrieved and printed. Information and flow information illustrated in FIG. 50 may be applied to like options illustrated in FIGS. 41-45 discussed later.

The system may allow a user to dual register a pet with one or more organizations. For example, a pet may be registered with the American Canine Association and with the International Pet Services Corporation. The registrations may include breed, sex, colors, store cost, initial price, sale price, PUP ID number, microchip number, information about tattoos and other markings, information about the sire and dam such as name, registry, registration number, and stud book code, the name of the breeder, distributor, and date acquired. The system may also allow addition of the same information about a litter. The user may also include the owner(s) name, date of commencing ownership, address, telephone number, e-mail address, animal's name. If the name has previously been registered to a different animal, the system may require the user to select another name under which to register the animal. Registration with these entities may be performed online via a global information network, such as the Internet. The user may pay for the registration using prepaid stickers or by using charge information. Table 156 may allow the user to print registration information after it has been accepted by the system.

FIG. 41 is a flow diagram illustrating how an animal owner may access and use predetermined, exemplary, functions of the present invention coupled with an automated electronic payment processing company in accordance with an exemplary embodiment of the present invention. More specifically, FIG. 41 is an exemplary flow chart showing Animal Owner Entrance (101) that allows the user to transfer between different predetermined applications of the present invention coupled with an automated electronic payment processing company. Option (104) allows the user to update personal information such as the name, address, phone number, e-mail address, and other information about the user. Option (104) utilizes Transfer (F1) to transfer information to Automated Internet Electronic Payment Company (15) for payment for services rendered for the user by the system. Option (106) allows the user to add new animal records to the system. Option (106) utilizes Transfer (F2) to transfer information to Automated Internet Electronic Payment Company (15) for payment for services rendered for the user by the system. Option (108) allows the user to query, update, edit existing animal records and utilizes Transfer (F3) to transfer information to Automated Internet Electronic Payment Company (15) for payment for services rendered for the user by the system. Option (110) allows the user to print selected records such as required government forms, medical records, bills of sale, and other historical information maintained by the database of the system and utilizes Transfer (F4) to transfer information to Automated Internet Electronic Payment Company (15) for payment for services rendered for the user by the system.

FIG. 42 is a flow diagram illustrating how a veterinarian may access and use predetermined, exemplary, functions in accordance with an exemplary embodiment of the present invention. More specifically, FIG. 42 is a flow chart showing Veterinary Entrance (102) that may allow the user to transfer between different predetermined applications of the present invention. Option (49) allows the veterinary user or their representative to update veterinarian, personnel, clinic, or institutional information such as name, address, phone number, e-mail address, and other information about the users of the system. Option (50) allows the user to add new animal records to the system. Option (51) allows the user to query, update, or edit existing animal records. Option (52) allows the user to print selected records use as required government forms, medical records, transaction logs, and other historical information maintained by the system.

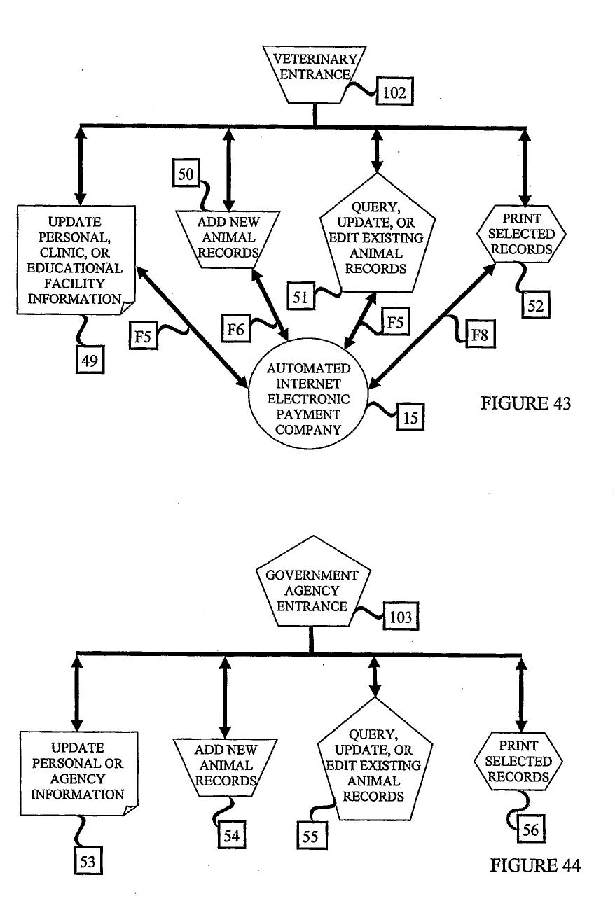

FIG. 43 is a flow diagram illustrating how a veterinarian may access and use predetermined, exemplary, functions in accordance with an exemplary embodiment of the present invention coupled with an automated electronic payment processing company. More specifically, FIG. 43 is an exemplary flow chart showing Veterinary Entrance (102) that allows the user to transfer between different predetermined applications of the present invention coupled with an automated electronic payment processing company. Option (49) allows the veterinary user or their representative to update veterinarian, personnel, clinic, or institutional inform such as name, address, phone number, e-mail address, and other information about the users of the system and utilizes Transfer (F5) to transfer information to Automated Internet Electronic Payment Company (15) for payment for services rendered by the system. Option (50) allows the user to add new animal records to the system and utilizes Transfer (F6) to transfer information to Automated Internet Electronic Payment Company (15) for payment for services rendered by the system. Option (51) allows the user to query, update, or edit existing animal records and utilizes Transfer (F7) to transfer information to Automated Internet Electronic Payment Company (15) for payment for services rendered by the system. Option (52) allows the user to print selected records such as required government forms, medical records, transfer logs, and other historical information maintained by the system and utilizes Transfer (F8) to transfer information to Automated Internet Electronic Payment Company (15) for payment for services rendered by the system.

For example, Options (50) and (51) allow the user to include information about inoculations and deworming, surgical procedures, DNA testing, congenital defects, and death of a specific animal. The information entered may include a microchip number of the animal, the date, diagnosis, medical product used, procedure performed, and the results.

FIG. 44 is a flow diagram illustrating how a government representative may access and use predetermined, exemplary, functions in accordance with an exemplary embodiment of the present invention. More specifically, FIG. 44 is a flow chart showing Government Agency Entrance (103) that allows the user to transfer between different predetermined applications of the present invention. Option (53) allows the government representative or their assignee the ability to update government agency, government personnel, government sub-contractors or assignees, animal control centers, animal control offers, humane societies, humane offers, animal shelters, to research, update, or to edit information such as name, address, phone number, e-mail address, and other information about the users of the system. Option (54) allows the user to add new animal records to the system. Option (55) allows the user to query, update, or edit existing animal records. Option (56) allows the user to print selected records such as required government forms, medical records, transaction logs, inspection records, and other historical information maintained by the database in the system.

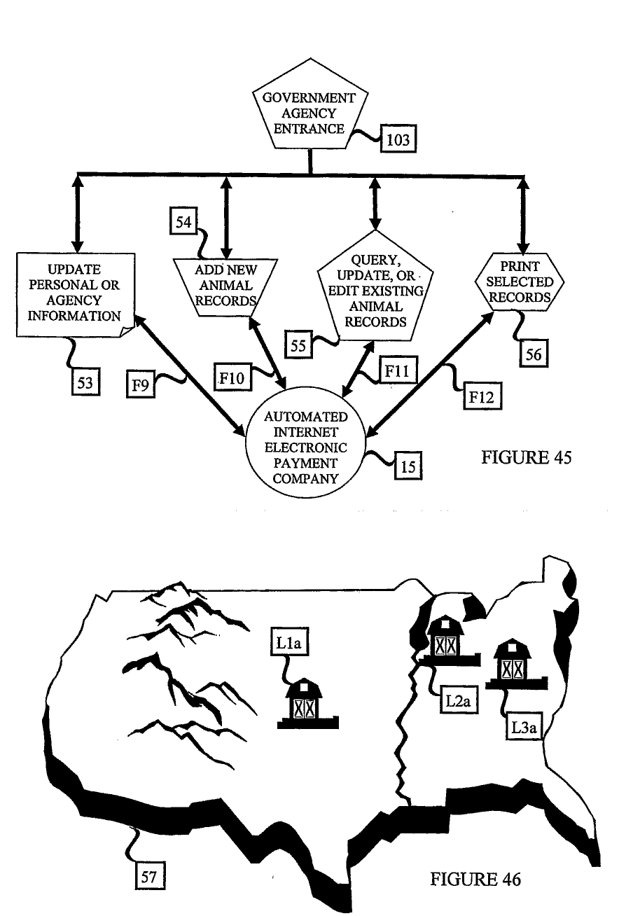

FIG. 45 is a flow diagram illustrating how a government representative may access and use predetermined, exemplary, functions in accordance with an exemplary embodiment of the present invention coupled with an automated electronic payment processing company. More specifically, FIG. 45 is an exemplary flow chart showing a Government Agency Entrance (103) that allows the user to transfer between different predetermined applications of the present invention coupled with an automated electronic payment processing company. Option (53) allows the government representative or their assignee the ability to update government agency, government personnel, government sub-contractors or assignees, animal control centers, animal control offers, humane societies, humane offers, animal shelters, to research, update, or edit information such as name, address, phone number, e-mail address, and other information about the users of the system and utilizes Transfer (F9) to transfer information to Automated Internet Electronic Payment Company (15) for payment for services rendered by the system. Option (54) allows the user to add new animal records to the system and utilizes Transfer (F10) to transfer information to Automated Internet Electronic Payment Company (15) for payment for services rendered by the system. Option (55) allows the user to query, update, or edit existing animal records and utilizes utilize Transfer (F11) to transfer information to Automated Internet Electronic Payment Company (15) for payment for services rendered by the system. Option (56) allows the user to print selected records use as required government forms, medical records, transfer logs, inspection records and other historical information maintained by the system and utilizes Transfer (F12) to transfer information to Automated Internet Electronic Payment Company (15) for payment for services rendered by the system.

The system may also allow a store to retrieve information about animals that are located in the store and are available for sale in the store, such as how long an animal has been in the store, the price paid by the store, breed, and registration number. When someone purchases an animal from a store, the store may enter information about the customer into the system such as name, address, telephone number, a description of the animal sold, including registration number, the salesperson, and method of payment, and the sale price.

FIG. 46 is a graphic overview illustrating the table in FIG. 22 in accordance with an exemplary embodiment of the present invention. More specifically, FIG. 46 shows Map (57) illustrating a geographical representation of the United States of America. Animal Location Area (L1a) is a graphic representative of Location Id Number (L1) of Table (T3) in FIG. 22. Animal Location Area (L2a) is a graphic representative of Location Id Number (L2) of Table (T3) in FIG. 22 Animal Location Area (L3a) is a graphic representative of Location Id Number (L3) of Table (T3) in FIG. 22.

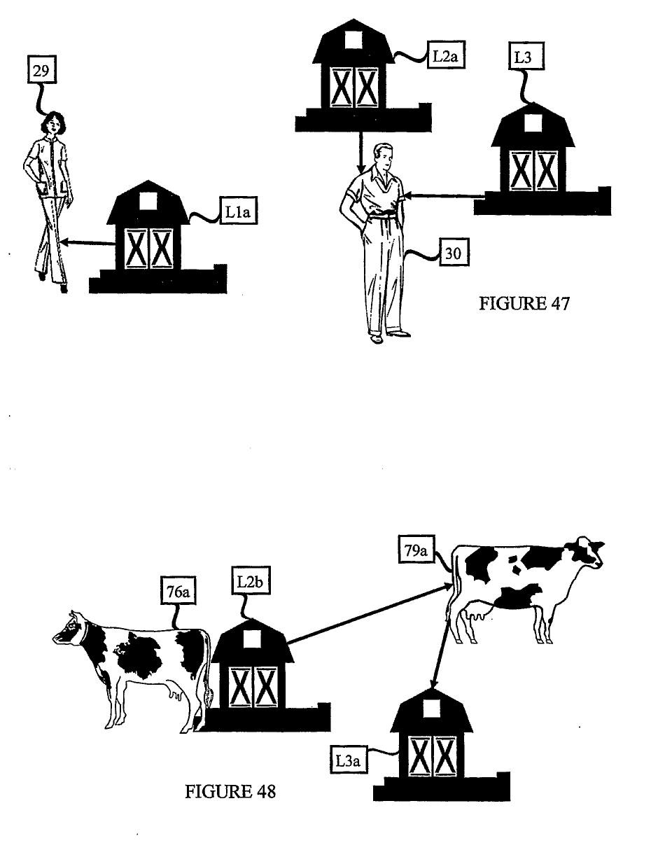

FIG. 47 is a graphic overview illustrating how an exemplary embodiment of the present invention may link multiple owners of animals to one or more physical locations. More specifically, FIG. 47 is a graphic overview illustrating Past Animal Owner (29) and her illustrative direct association with Animal Location Area (L1a). Additionally, Animal Owner (30) is shown with illustrative direct association with multiple animal locations such as illustrative Animal Location Area (L2a) and illustrative Animal Location Area (L3a).

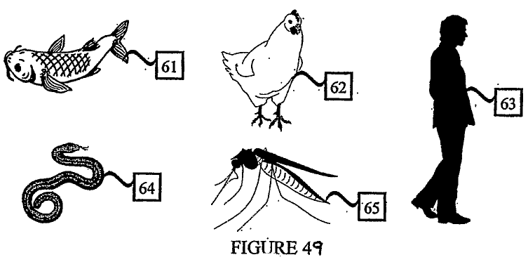

FIG. 48 is a graphic overview illustrating the table in FIG. 22 in accordance with an exemplary embodiment of the present invention. More specifically, FIG. 48 is a graphic overview of Table (T3) in FIG. 22. Animal (76a) illustratively currently resides at illustrative Animal Location Area (L2b). Animal (79a) illustratively was transferred from illustrative Animal Location Area (L2a) to illustrative Animal Location Area (L3a).

FIG. 49 is a graphic representation of other living creators that may be tracked by the present invention after having a microchip placed on or in them. More specifically, FIG. 49 is a graphic illustration of an exemplary aspect of the system that may be used to track other living creatures including, but not limited to; Aquatic Creature (61), Birds (62), Human (63), Reptile (64), Insect (65).

Although illustrated and described herein with reference to certain specific embodiments, the present invention is nevertheless not intended to be limited to the details shown. Rather, various modifications may be made in the details within the scope and range of equivalents of the claims and without departing from the spirit of the invention. It will also be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method for use with a computer system for at least one of storing, tracking, and/or retrieving information by authorized users relating to at least one animal, the method comprising:
assigning respective first identifiers to respective authorized users of the computer based system for allowing the authorized users access to the system;
assigning respective second identifiers to respective ones of the at least one animal;
storing the first and second identifiers in a database;
creating a plurality of data fields, each one of the plurality of data fields for storing respective data about the at least one animal and for correlating the data with the respective second identifiers;
defining a plurality of access levels for allowing access to the data, each one of the access levels designating at least one category of data accessible by respective ones of the authorized users of the system; and
entering at least a portion of the data about the at least one animal into the computer system, the data being correlated to respective ones of the second identifiers.

2. The method of claim 1, further comprising coupling the computer system to a global communication network.

3. The method of claim 1, wherein the computer system comprises a server and at least one client system.

4. The method of claim 3, wherein the data is entered via the client system.

5. The method of claim 3, wherein at least a portion of the data is stored on the server.

6. The method of claim 3, wherein the data is retrieved from the server by the at least one client system.

7. The method of claim 1, further comprising storing the data on a server.

8. The method of claim 7, further comprising retrieving the data from the server.

9. The method of claim 1, wherein the authorized users are at least one of an owner of an animal, a possessor of an animal, a store, a breeder, a distributor, a veterinarian, and/or a government agency.

10. The method of claim 9, wherein the authorized users access the data via a client system.

11. A client usable computer based method for use with a server for at least one of storing, tracking, and retrieving information by authorized client systems of a computer based system relating to at least one animal, the method comprising:
storing data about the at least one animal in the computer based system;
designating respective selected portions of the data for access by respective ones of the client systems;
assigning identifiers to respective users of respective client systems for allowing the respective users access to the respective selected portions of the data; and
at least one of entering the data, modifying the data, tracking the data, and retrieving the data.

12. The method of claim 11, further comprising defining a plurality of access levels for allowing access to the data, each one of the access levels designating at least one category of data accessible by respective ones of the users of the system.

13. The method of claim 11, further comprising paying for at least one service performed by the server by at least one of a credit card, an ATM bank card, a personal check, a prepaid coupon, and/or other form of electronic payment.

14. The method of claim 11, wherein the users are authorized computers.

15. The method of claim 11, further comprising retrieving data from the computer based system and storing the data at a second location.

16. The method of claim 12, wherein the plurality of access levels allow at least one of full access to the data, limited access to the data, and read only access to the data.

17. A method for use with a processor for making available historical data about an animal to at least one of a plurality of data retrievers comprising at least one of an owner, a veterinarian, a breeder, an entity possessing the animal, and/or a government entity, the data being supplied by a plurality of data sources comprising at least one of the owner, the veterinarian, the breeder, and/or the entity possessing the animal, the method comprising:
assigning an animal identifier to the animal;
assigning a respective source identifier to each of the data sources;
receiving historical data from at least one data source;
linking the animal identifier to the received data and to the respective source identifier;
storing the linked historical data as a portion of a database in a memory;
assigning a respective access code to each one of the plurality of data retrievers for providing the respective data retriever access to at least a predetermined portion of the historical data;
transmitting the access code from the data retriever to the database; and
transferring the predetermined portion of the historical data to the data retriever.

18. The method of claim 17, wherein the animal identifier is unique.

19. The method of claim 17, wherein the source identifier is unique.

20. A method for making available historical data about an animal to at least one of a plurality of data retrievers comprising at least one of an owner, a veterinarian, a breeder, an entity possessing the animal, and/or a government entity, the data being supplied by a plurality of data sources comprising at least one of the owner, the veterinarian, the breeder, and the entity possessing the animal, the method comprising the steps of:
assigning a unique identifier to the animal;
assigning a respective source identifier to each of the data sources;
receiving historical data from at least one of the plurality of data sources;
linking the animal identifier to the received data and to the respective source identifier;
storing the linked historical data as a portion of database in a memory;
assigning a respective access code to each one of the plurality of data retrievers for providing the respective data retriever access to at least a predetermined portion of the historical data;
transmitting the access code from the data retriever to the database; and
transferring the predetermined portion of the historical data from the database to the data retriever based at least on the access code of the data retriever.

21. A method of monitoring a history of an animal, the method comprising:
assigning a unique identifier to the animal;
storing the unique identifier in a database;
creating a plurality of data fields, each one of the plurality of data fields recording a respective characteristic of the history;
coupling each of the data fields to the identifier;
storing each of the coupled data fields in the database;
creating at least one data table, the at least one data table comprising selected ones of the data fields;
coupling the at least one data table to the identifier;
storing the at least one coupled data table in the data base;
assigning at least one security code to a user allowing the user to input information in predetermined fields based on a status of the user; and
obtaining access to at least one characteristic of the history based on security code.

22. The method of claim 21, wherein the at least one characteristic of the history comprises a breeding record of the animal.

23. The method of claim 21, wherein the at least one characteristic of the history comprises a veterinary record of the animal.

24. The method of claim 21, wherein the at least one characteristic of the history comprises an identification of the animal.

25. The method of claim 21, wherein the at least one characteristic of the history comprises an historical location record of the animal.

26. The method of claim 21, wherein the at least one characteristic of the history comprises a colony record of the animal.

27. The method of claim 21, wherein the at least one characteristic of the history comprises an historical lineage record of the animal.

28. The method of claim 21, wherein the at least one characteristic of the history comprises an historical ownership record of the animal.
